(19) United States
(12) Patent Application Publication
(10) Pub. No.: US 2026/0309325 A1
(43) Pub. Date: Oct. 8, 2026

(54) AMMONIA CRACKING SYSTEM AND METHOD FOR CRACKING AMMONIA

(71) Applicant: IHI Corporation, Tokyo (JP)

(72) Inventors: Koukichi ABE, Tokyo (JP); Kodai IWANAGA, Tokyo (JP); Masahiro UCHIDA, Tokyo (JP); Shintaro ITO, Tokyo (JP)

(73) Assignee: IHI Corporation, Tokyo (JP)

(21) Appl. No.: 19/682,721

(22) Filed: May 20, 2026

Related U.S. Application Data
(63) Continuation of application No. PCT/JP2024/038637, filed on Oct. 30, 2024.

(30) Foreign Application Priority Data
Nov. 22, 2023 (JP) 2023-198469

(51) Int. Cl. F23C 13/06; C01B 3/047

(52) U.S. Cl. CPC F23C 13/06; C01B 3/047

(57) ABSTRACT

An ammonia cracking system includes a first line that is provided with ammonia, a cracker that is provided in the first line and that generates cracked gas containing hydrogen from the ammonia, and a second line that is fluidly connected to the first line at a position downstream of the cracker, the second line supplying liquid ammonia to the cracked gas flowing through the first line to generate mixed gas.

### CROSS REFERENCE TO RELATED APPLICATIONS

This application is a continuation application of International Application No. PCT/JP2024/038637, filed on Oct. 30, 2024, which claims priority to Japanese Patent Application No. 2023-198469 filed on Nov. 22, 2023, the entire contents of which are incorporated herein by reference.

### BACKGROUND ART

### Technical Field

The present disclosure relates to an ammonia cracking system and a method for cracking ammonia.

Ammonia is known as a fuel that does not emit CO₂. Ammonia has flame retardancy. Accordingly, prior to combustion, at least a portion of ammonia may be cracked into a gas containing hydrogen. Hydrogen combusts more readily than ammonia. However, the cracked gas from ammonia has high temperature. Such cracked gas may cause problems such as nitriding and hydrogen embrittlement of piping.

For example, Patent Literature 1 discloses an ammonia cracker. In the ammonia cracker, cracked gas flowing out from a reactor is cooled in a cooler. The cooler exchanges heat between liquid ammonia before cracking and the cracked gas.

### Citation List

### Patent Literature

Patent Literature 1: WO 2022/153719 A1

### Summary

### Technical Problem

As disclosed in Patent Literature 1, for example, it is conceivable to install a cooler such as a heat exchanger in a flow path of cracked gas to cool the cracked gas. In this case, a refrigerant supply system is required. Furthermore, a control system becomes complex to control output of the heat exchanger.

The present disclosure aims to provide an ammonia cracking system and a method for cracking ammonia that can cool cracked gas from ammonia.

### Solution to Problem

An ammonia cracking system according to one aspect of the present disclosure includes a first line that is provided with ammonia, a cracker that is provided in the first line and that generates cracked gas containing hydrogen from the ammonia, and a second line that is fluidly connected to the first line at a position downstream of the cracker, the second line supplying liquid ammonia to the cracked gas flowing in the first line to generate mixed gas.

The ammonia cracking system may include a mixer that is provided in the first line at a position downstream of the cracker and that mixes the cracked gas from the cracker with the liquid ammonia from the second line.

The ammonia cracking system may include a tank that is fluidly connected to the first line and the second line, the tank including a chamber for storing ammonia in two phases including gaseous ammonia and liquid ammonia, the first line being connected to an upper portion of the chamber, the second line being connected to a lower portion of the chamber.

The ammonia cracking system may include a tank that is fluidically connected to the first line and the second line, the tank supplying liquid ammonia to each of the first line and the second line, and a vaporizer that is provided in the first line between the tank and the cracker and that heats the liquid ammonia flowing through the first line to generate gaseous ammonia.

The ammonia cracking system may include a first adjuster that is provided in the first line at a position upstream of the cracker and that adjusts a flow rate of the ammonia flowing through the first line, a second adjuster that is provided in the second line and that adjusts a flow rate of the liquid ammonia flowing through the second line, and a controller that is communicatively connected to the first adjuster and the second adjuster, the controller being configured to execute obtaining an apparent cracking rate of the gaseous ammonia cracked in the cracker in the mixed gas, obtaining temperature of the mixed gas, and controlling the first adjuster and the second adjuster such that the apparent cracking rate does not fall below a predetermined lower limit and the temperature of the mixed gas does not exceed a predetermined upper limit.

A method for cracking ammonia according to another aspect of the present disclosure includes supplying ammonia to a first line, generating cracked gas containing hydrogen from the ammonia by a cracker that is provided in the first line, and supplying liquid ammonia from a second line that is fluidly connected to the first line at a position downstream of the cracker to the cracked gas flowing through the first line to generate mixed gas.

### Effects

According to the present disclosure, cracked gas from ammonia can be cooled.

### BRIEF DESCRIPTION OF DRAWINGS

FIG. 1 is a schematic diagram showing an ammonia cracking system according to a first embodiment.

FIG. 2 is a schematic diagram showing an ammonia cracking system according to a second embodiment.

FIG. 3 is a schematic diagram showing an ammonia cracking system according to a third embodiment.

FIG. 4 is a schematic diagram showing an ammonia cracking system according to a fourth embodiment.

FIG. 5 is a flowchart showing an example of operation of the ammonia cracking system according to the fourth embodiment.

FIG. 6 is a flowchart showing another example of operation of the ammonia cracking system according to the fourth embodiment.

### DESCRIPTION OF EMBODIMENTS

Embodiments of the present disclosure will be described in detail below with reference to the accompanying drawings. Specific dimensions, materials, and numerical values described in the embodiments are merely examples for better understanding, and do not limit the present disclosure unless otherwise specified. In this specification and the drawings, duplicate explanations are omitted for elements having substantially the same functions and configurations by assigning the same sign. Furthermore, elements not directly related to the present disclosure are omitted from the figures.

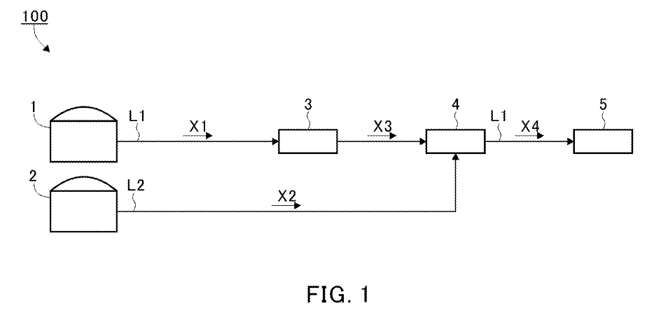

FIG. 1 is a schematic diagram showing an ammonia cracking system 100 according to a first embodiment. In the present disclosure, the ammonia cracking system may simply be referred to as the "system." For example, the system 100 includes a first tank (ammonia supply source) 1, a second tank (liquid ammonia supply source) 2, a cracker 3, and a mixer 4. The system 100 may further include other components. Furthermore, the system 100 may not include one or more of the above components.

The first tank 1 stores ammonia. For example, in the present embodiment, the first tank 1 stores gaseous ammonia X1. The first tank 1 is connected to a first line L1. For example, the first line L1 includes one or more pipes. The first tank 1 supplies the gaseous ammonia X1 to the first line L1. For example, the first tank 1 may include a valve and may supply the gaseous ammonia X1 to the first line L1 at a flow rate corresponding to a degree of opening of the valve and pressure within the first tank 1. Alternatively, or additionally, the first line L1 may include a compressor and a valve for adjusting the flow rate of the gaseous ammonia X1. For example, in other embodiments, a gaseous ammonia manufacturing apparatus may be used as the ammonia supply source instead of the first tank 1.

The second tank 2 stores liquid ammonia X2. The liquid ammonia X2 is stored at a low temperature. For example, under atmospheric pressure, the liquid ammonia X2 is stored at a temperature lower than -33° C. The second tank 2 is connected to a second line L2. For example, the second line L2 includes one or more pipes. The second tank 2 supplies the liquid ammonia X2 to the second line L2. For example, the second tank 2 may include a valve and may supply the liquid ammonia X2 to the second line L2 at a flow rate corresponding to a degree of opening of the valve and pressure within the second tank 2. Alternatively, or additionally, the second line L2 may include a pump and a valve for adjusting the flow rate of the liquid ammonia X2. For example, in other embodiments, a liquid ammonia manufacturing apparatus may be used as the liquid ammonia supply source instead of the second tank 2.

The cracker 3 is provided in the first line L1. The cracker 3 is connected to the first tank 1 via the first line L1, and is in fluid communication with the first tank 1. The gaseous ammonia X1 is supplied from the first tank 1 to the cracker 3 via the first line L1. The cracker 3 generates cracked gas X3 containing hydrogen from the gaseous ammonia X1 flowing through the first line L1. The cracked gas X3 may contain unreacted ammonia that was not cracked.

For example, the cracker 3 may include a heater for heating the ammonia. For example, heating ammonia to approximately 600 to 800° C allows most of the ammonia to be cracked into hydrogen and nitrogen. In this case, the cracked gas X3 reaches a high temperature of approximately 600 to 800° C.

Alternatively or additionally, the cracker 3 may include a catalyst for cracking ammonia into hydrogen and nitrogen. Generally, the catalyst is inactive below a predetermined temperature. Accordingly, the catalyst is heated to the predetermined temperature, for example, to approximately 500 to 600° C. In this case, the cracked gas X3 reaches a high temperature of approximately 500 to 600° C.

For example, the catalyst may contain a transition element (also referred to as transition metal). For example, the catalyst may contain a precious metal such as Ru. Furthermore, for example, the catalyst may contain a non-precious metal among transition elements, such as Fe, Co, Ni, Cu, and the like. Non-precious metals may exhibit high activity when combined with specific supports. As a support, an oxide such as Al₂O₃ or SiO₂ may be used. Furthermore, if necessary, a support that can curb sintering, such as CeO₂, may be used.

The mixer 4 is provided in the first line L1 at a position downstream of the cracker 3. The mixer 4 is connected to the cracker 3 via the first line L1, and is in fluid communication with the cracker 3. The cracked gas X3 is supplied from the cracker 3 to the mixer 4 via the first line L1.

In the present embodiment, the second line L2 is directly connected to the mixer 4. The mixer 4 is connected to the second tank 2 via the second line L2, and is in fluid communication with the second tank 2. The liquid ammonia X2 is supplied from the second tank 2 to the mixer 4 via the second line L2. In other embodiments, the second line L2 may be connected to the first line L1 between the cracker 3 and the mixer 4.

The mixer 4 mixes the cracked gas X3 from the cracker 3 with the liquid ammonia X2 from the second line L2. For example, the mixer 4 may be various types of mixers, such as an in-line mixer. As described above, the cracked gas X3 has high temperature. Accordingly, the liquid ammonia X2 vaporizes due to heat from the cracked gas. Furthermore, the cracked gas X3 is cooled by the vaporization of the liquid ammonia X2. Consequently, the temperature of a mixed gas X4 generated in the mixer 4 is lower than the temperature of the cracked gas X3 generated in the cracker 3. For example, the mixed gas X4 may contain gaseous ammonia, liquid ammonia, hydrogen, and nitrogen.

For example, if the temperature of the mixed gas X4 is higher than an intended range, an operator may increase the amount of liquid ammonia by adjusting the degree of opening of the valve of the second tank 2. Alternatively, or additionally, the operator may reduce the amount of gaseous ammonia by adjusting the degree of opening of the valve of the first tank 1.

In contrast, for example, if the temperature of the mixed gas X4 is lower than the intended range, the operator may reduce the amount of liquid ammonia by adjusting the degree of opening of the valve of the second tank 2. Alternatively, or additionally, the operator may increase the amount of gaseous ammonia by adjusting the degree of opening of the valve of the first tank 1.

In other embodiments, the valve of each of the first tank 1 and the second tank 2 may be fixed at a predetermined degree of opening so that the temperature of the mixed gas X4 falls within the intended range.

In the present embodiment, the system 100 is applied to a combustion system including the ammonia cracking system 100 and a combustor 5, and the mixed gas X4 from the system 100 is used as a fuel in the combustor 5. For example, the combustor 5 may be used in equipment such as a gas turbine or a boiler. Equipment using the combustor 5 is not limited to thereto. In other embodiments, the system 100 may be applied to other systems including devices other than the combustor 5.

The system 100 as described above includes the first line L1 that is provided with the gaseous ammonia X1, the cracker 3 that is provided in the first line L1 and that generates the cracked gas X3 containing hydrogen from the gaseous ammonia X1, and the second line L2 that is fluidly connected to the first line L1 at a position downstream of the cracker 3, wherein the second line L2 supplies the liquid ammonia X2 to the cracked gas X3 flowing through the first line L1 and generates the mixed gas X4. Furthermore, the method according to the present embodiment includes supplying the gaseous ammonia X1 to the first line L1, generating the cracked gas X3 containing hydrogen from the gaseous ammonia X1 by the cracker 3 provided in the first line L1, and supplying the liquid ammonia X2 from the second line L2 that is fluidly connected to the first line L1 at a position downstream of the cracker 3 to the cracked gas X3 flowing in the first line L1 to generate the mixed gas X4. According to such configurations, the liquid ammonia X2 from the second line L2 vaporizes due to heat from the cracked gas X3 from the cracker 3. Furthermore, the cracked gas X3 is cooled by the vaporization of the liquid ammonia X2. As a result, the temperature of the mixed gas X4 is lower than the temperature of the cracked gas X3 generated in the cracker 3. Accordingly, the cracked gas X3 can be cooled.

Furthermore, the system 100 includes the mixer 4 that is provided in the first line L1 at a position downstream of the cracker 3 and that mixes the cracked gas X3 from the cracker 3 with the liquid ammonia X2 from the second line L2. According to such a configuration, the cracked gas X3 can be cooled more uniformly.

Furthermore, the system 100 may include the first tank 1 that is fluidly connected to the first line L1 and that stores the gaseous ammonia X1, and the second tank 2 that is fluidly connected to the second line L2 and that stores the liquid ammonia X2.

Next, other embodiments will be described.

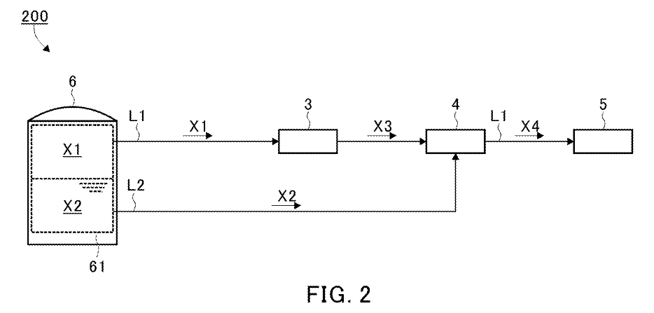

FIG. 2 is a schematic diagram showing an ammonia cracking system 200 according to a second embodiment. The system 200 differs from the above-described system 100 in that that system 200 includes a third tank 6 instead of the above-described first tank 1 and second tank 2. In other configurations, that system 200 may be the same as the system 100.

The third tank 6 includes a chamber 61. The chamber 61 stores ammonia in two phases including the gaseous ammonia X1 and the liquid ammonia X2. The gaseous ammonia X1 is stored in an upper part of the chamber 61, and the liquid ammonia X2 is stored in a lower part of the chamber 61.

The first line L1 is connected to the upper part of the chamber 61. Accordingly, the third tank 6 supplies the gaseous ammonia X1 from the chamber 61 to the first line L1. For example, the third tank 6 may include a valve for the first line L1 and may supply the gaseous ammonia X1 to the first line L1 at a flow rate corresponding to a degree of opening of the valve and pressure within the chamber 61.

The second line L2 is connected to the lower part of the chamber 61. Accordingly, the third tank 6 supplies the liquid ammonia X2 from the chamber 61 to the second line L2. For example, the third tank 6 may include a valve for the second line L2 and may supply the liquid ammonia X2 to the second line L2 at a flow rate corresponding to a degree of opening of the valve and the pressure within the chamber 61.

The system 200 as described above has similar effects to those of the system 100.

In particular, the system 200 includes the third tank 6 that is fluidly connected to the first line L1 and the second line L2. The third tank 6 includes the chamber 61 that stores ammonia in two phases including the gaseous ammonia X1 and the liquid ammonia X2. The first line L1 is connected to the upper part of the chamber 61, and the second line L2 is connected to the lower part of the chamber 61. This configuration allows both the gaseous ammonia X1 and the liquid ammonia X2 to be stored in the same third tank 6. Consequently, space and cost required for installing the tank can be reduced.

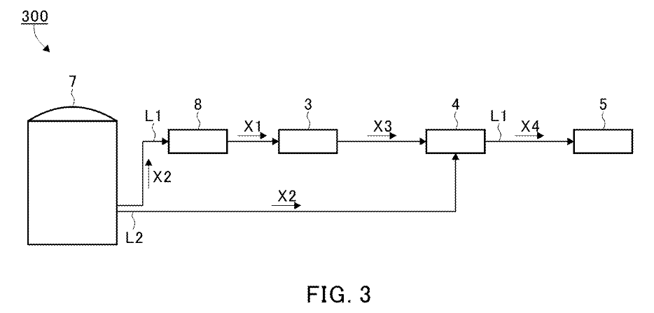

FIG. 3 is a schematic diagram showing an ammonia cracking system 300 according to a third embodiment. The system 300 differs from the above-described system 100 in that the system 300 includes a fourth tank (liquid ammonia supply source) 7 and a vaporizer 8 instead of the above-described first tank 1 and second tank 2. In other configurations, the system 300 may be the same as the system 100.

The fourth tank 7 stores the liquid ammonia X2. The fourth tank 7 is connected to both the first line L1 and the second line L2. The fourth tank 7 supplies the liquid ammonia X2 to both the first line L1 and the second line L2. Accordingly, in the present embodiment, the first line L1 receives a supply of the liquid ammonia X2 instead of the gaseous ammonia X1. For example, the fourth tank 7 may include a valve for each of the first line L1 and the second line L2, and may supply the liquid ammonia X2 to each of the first line L1 and the second line L2 at a flow rate corresponding to a degree of opening of the valve and pressure within the fourth tank 7.

The vaporizer 8 is provided in the first line L1 between the fourth tank 7 and the cracker 3. The vaporizer 8 is connected to the fourth tank 7 via the first line L1, and is in fluid communication with the fourth tank 7. The liquid ammonia X2 is supplied to the vaporizer 8 from the fourth tank 7 via the first line L1. The vaporizer 8 heats the liquid ammonia X2 flowing through the first line L1 to generate gaseous ammonia X1. The gaseous ammonia X1 may contain liquid ammonia that did not vaporize. For example, the vaporizer 8 may use a fluid having a higher temperature than the liquid ammonia X2, such as exhaust gas from the combustor 5 or seawater, as a heating medium. The vaporizer 8 is connected to the cracker 3 via the first line L1, and is in fluid communication with the cracker 3. The vaporizer 8 supplies the gaseous ammonia X1 to the cracker 3 via the first line L1.

The system 300 as described above has similar effects to those of the system 100.

In particular, the system 300 includes the fourth tank 7 that is fluidly connected to the first line L1 and the second line L2, wherein the fourth tank 7 supplies the liquid ammonia X2 to each of the first line L1 and the second line L2, and the vaporizer 8 that is provided in the first line L1 between the fourth tank 7 and the cracker 3 and that heats the liquid ammonia X2 flowing through the first line L1 to generate the gaseous ammonia X1. According to such a configuration, the liquid ammonia X2 can be supplied to both the first line L1 and the second line L2 from the same fourth tank 7. Consequently, space and cost required for installing the tank can be reduced.

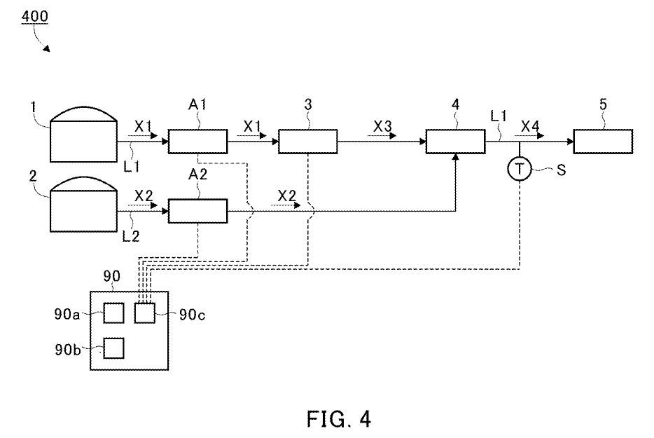

FIG. 4 is a schematic diagram showing an ammonia cracking system 400 according to a fourth embodiment. The system 400 differs from the above-described system 100 in that the system 400 includes a first adjuster A1, a second adjuster A2, a temperature sensor S, and a controller 90. In other configurations, the system 400 may be the same as the system 100.

The first adjuster A1 is provided in the first line L1 at a position upstream of the cracker 3, in the present embodiment, between the first tank 1 and the cracker 3. The first adjuster A1 adjusts a flow rate of the gaseous ammonia X1 flowing through the first line L1. For example, the first adjuster A1 may include a flow controller capable of measuring the flow rate of the gaseous ammonia X1 and adjusting the flow rate of the gaseous ammonia X1. Alternatively, or additionally, for example, the first adjuster A1 may include a flow meter and at least one valve. The first adjuster A1 is communicatively connected to the controller 90 and transmits measurement data to the controller 90. The controller 90 is configured to adjust the flow rate of the gaseous ammonia X1 flowing through the first line L1 by controlling the first adjuster A1.

The second adjuster A2 is provided in the second line L2. In the present embodiment, the second adjuster A2 is provided between the second tank 2 and the mixer 4. The second adjuster A2 adjusts a flow rate of the liquid ammonia X2 flowing through the second line L2. For example, the second adjuster A2 may include a flow controller capable of measuring the flow rate of the liquid ammonia X2 and adjusting the flow rate of the liquid ammonia X2. Alternatively, or additionally, for example, the second adjuster A2 may include a flow meter and at least one valve. The second adjuster A2 is communicatively connected to the controller 90 and transmits measurement data to the controller 90. The controller 90 is configured to adjust the flow rate of the liquid ammonia X2 flowing through the second line L2 by controlling the second adjuster A2.

The temperature sensor S is provided in the first line L1 at a position downstream of a connection point with the second line L2 (mixer 4), in the present embodiment, between the mixer 4 and the combustor 5. The temperature sensor S measures temperature of the mixed gas X4 flowing through the first line L1. The temperature sensor S is communicatively connected to the controller 90 and transmits measurement data to the controller 90.

The controller 90 controls the entire system 400 or a portion thereof. Furthermore, the controller 90 may control the combustor 5, and may control the entire combustion system including the system 400 and the combustor 5. For example, the controller 90 may be configured by one or more PCs. The controller 90 includes components such as a processor 90a, a memory 90b, and a connector 90c, and these components are connected to each other via buses. For example, the processor 90a includes a CPU (Central Processing Unit), etc. For example, the memory device 90b includes a hard disk, ROM where programs are stored, and RAM serving as a work area, etc. The controller 90 is communicatively connected via the connector 90c to each component of the system 400 and the combustor 5 by wire or wirelessly. For example, the controller 90 may further include other components such as a display like an LCD or a touch panel, and an input device like a keyboard, buttons, or a touch panel. For example, the following operations of the controller 90 may be realized by executing programs stored in the memory 90b by the processor 90a.

The controller 90 is communicatively connected to the cracker 3 and controls output of the cracker 3. By controlling the output of the cracker 3, the controller 90 can adjust a cracking rate in the cracker 3. In the present disclosure, the "cracking rate" may be defined as a ratio of the amount of gaseous ammonia X1 cracked in the cracker 3 to the amount of gaseous ammonia X1 flowing into the cracker 3. For example, the controller 90 may store in advance in the memory 90b a map or a formula showing a relationship between the output of the cracker 3, the flow rate of the gaseous ammonia X1, and the cracking rate. The map or the formula indicates the cracking rate corresponding to the output of the cracker 3 and the flow rate of the gaseous ammonia X1. Furthermore, for example, the controller 90 may store in advance in the memory 90b a map or a formula showing a relationship between the output of the cracker 3, the flow rate of the gaseous ammonia X1, and the temperature of the cracked gas X3 at an outlet of the cracker 3. The map or the formula indicates the temperature of the cracked gas X3 corresponding to the output of the cracker 3 and the flow rate of the gaseous ammonia X1. For example, the maps and the formulas may be determined by experiment or analysis.

For example, the controller 90 may calculate the cracking rate R1 at the outlet of the cracker 3 and the amount FG1 of gaseous ammonia X1 cracked in the cracker 3 based on the output of the cracker 3, the flow rate FG0 of gaseous ammonia X1 received from the first adjuster A1, and the stored map or formula. Furthermore, the controller 90 may calculate temperature T1 of the cracked gas X3 at the outlet of the cracker 3 based on the output of the cracker 3, the flow rate FG0 of the gaseous ammonia X1, and the stored map or formula.

The controller 90 may calculate the amount FL1 of gaseous ammonia vaporized from the liquid ammonia X2 in the mixer 4 and the temperature T2 of the mixed gas X4 at the outlet of the mixer 4 based on the flow rate FG0 of the gaseous ammonia X1, the amount FG1 of cracked gaseous ammonia X1, the temperature T1 of the cracked gas X3, and the flow rate FL0 of the liquid ammonia X2 received from the second adjuster A2.

The controller 90 may calculate an apparent cracking rate R2 in the mixed gas X4 based on the flow rate FG0 of the gaseous ammonia X1, the amount FG1 of cracked gaseous ammonia X1, and the amount FL1 of gaseous ammonia vaporized from the liquid ammonia X2. In the present disclosure, the "apparent cracking rate" may be defined as a ratio of the amount of gaseous ammonia X1 cracked in the cracker 3 to the total of the amount of gaseous ammonia X1 flowing into the cracker 3 and the amount of liquid ammonia X2 flowing into the mixer 4. The apparent cracking rate R2 correlates with hydrogen concentration in the mixed gas X4.

For example, to reduce the temperature T1 of the cracked gas X3, the flow rate of the liquid ammonia X2 can be increased. However, excessively increasing the flow rate of the liquid ammonia X2 increases the amount of gaseous ammonia vaporized from the liquid ammonia X2 in the mixer 4. Consequently, concentration of gaseous ammonia in the mixed gas X4 increases, and concentration of hydrogen in the mixed gas X4 decreases. That is, the apparent cracking rate R2 in the mixed gas X4 decreases. This leads to a decrease in the combustibility of the mixed gas X4. Accordingly, the controller 90 may control the first adjustor A1 and the second adjustor A2 to adjust the flow rate of the gaseous ammonia X1 and the flow rate of the liquid ammonia X2 so that the temperature T2 of the mixed gas X4 received from the temperature sensor S or the temperature T2 of the mixed gas X4 calculated as described above does not exceed a predetermined upper limit and the apparent cracking rate R2 calculated as described above does not fall below a predetermined lower limit.

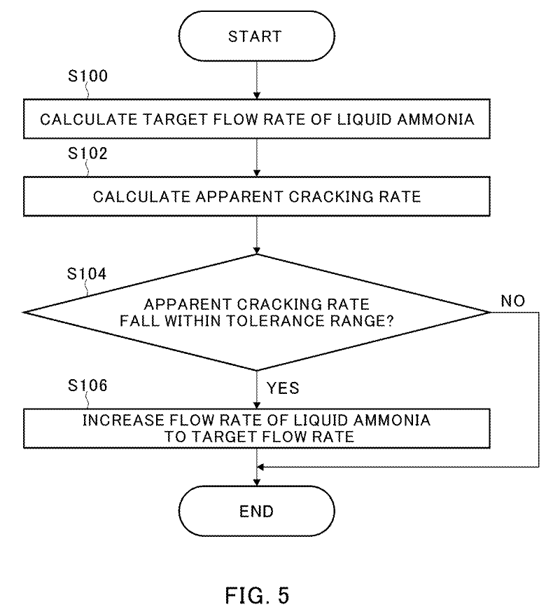

FIG. 5 is a flowchart showing an example of operation of the ammonia cracking system 400 according to the fourth embodiment.

For example, when increasing the total fuel supplied to the combustor 5 (the output of the combustor 5) while the flow rate of the gaseous ammonia X1 is restricted, the system 400 may operate as shown in FIG. 5. For example, the operation shown in FIG. 5 may be started when the system 400 receives an instruction to increase the output of the combustor 5. For example, in this state, the temperature T2 of the mixed gas X4 received from the temperature sensor S or the calculated temperature T2 of the mixed gas X4 is at or below the upper limit, and the calculated apparent cracking rate R2 is at or above the lower limit.

The processor 90a calculates a target flow rate of the liquid ammonia X2 required for target output of the combustor 5 based on the target output of the combustor 5 and the flow rate FG0 of the gaseous ammonia X1 (step S100). For example, the processor 90a may calculate a difference in output between the target output and the output of the combustor 5 obtained by the gaseous ammonia X1 of the flow rate FG0, and then calculate the flow rate of the liquid ammonia X2 required to achieve the calculated difference in output.

The processor 90a calculates the apparent cracking rate R2 based on the target flow rate of the liquid ammonia X2 calculated in step S100 and the flow rate FG0 of the gaseous ammonia X1 (step S102). As described above, the processor 90a can calculate the apparent cracking rate R2 with using the map or the formula stored in the memory 90b.

The processor 90a determines whether the apparent cracking rate R2 calculated in step S102 falls within a predetermined tolerance range or not (step S104). For example, the controller 90 may store the tolerance range in the memory 90b in advance, and the processor 90a may determine whether or not the calculated apparent cracking rate R2 falls within the tolerance range stored in the memory 90b. Specifically, the processor 90a may determine whether the apparent cracking rate R2 does not fall below the lower limit.

In step S104, if the apparent cracking rate R2 falls within the tolerance range (YES), the processor 90a controls the second adjuster A2 to increase the flow rate FL0 of the liquid ammonia X2 to the target flow rate calculated in step S100 (step S106), and terminates the operation. Note that when increasing the flow rate FL0 of the liquid ammonia X2, the temperature T2 of the mixed gas X4 decreases. Accordingly, the temperature T2 of the mixed gas X4 does not exceed the upper limit.

In step S104, if the apparent cracking rate R2 does not fall within the tolerance range (NO), the processor 90a terminates the operation. In this case, for example, the controller 90 may notify the operator via a display or sound that the output of the combustor 5 cannot be increased to the target output.

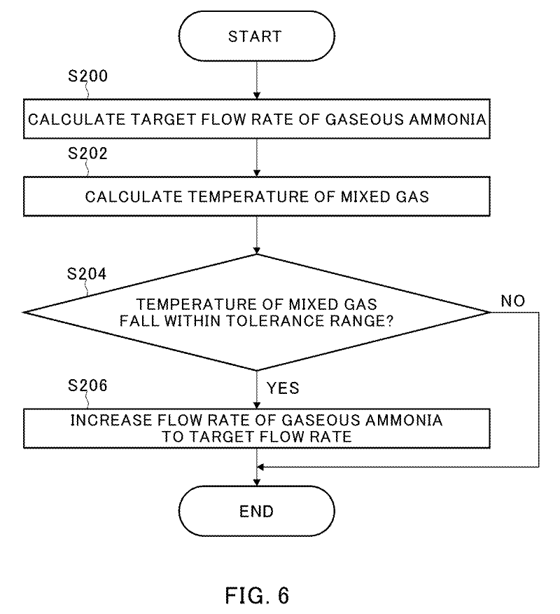

FIG. 6 is a flowchart showing another example of operation of the ammonia cracking system 400 according to the fourth embodiment.

For example, when increasing the total fuel supplied to the combustor 5 (the output of the combustor 5) while the flow rate of the liquid ammonia X2 is restricted, the system 400 may operate as shown in FIG. 6. For example, the operation shown in FIG. 6 may be started when the system 400 receives an instruction to increase the output of the combustor 5. For example, in this state, the temperature of the mixed gas X4 received from the temperature sensor or the calculated temperature T2 of the mixed gas X4 is at or below the upper limit, and the calculated apparent cracking rate R2 is at or above the lower limit.

The processor 90a calculates a target flow rate of the gaseous ammonia X1 required for target output of the combustor 5 based on the target output of the combustor 5 and the flow rate FL0 of the liquid ammonia X2 (step S200). For example, the processor 90a may calculate a difference in output between the target output and the output of the combustor 5 obtained by the liquid ammonia X2 of the flow rate FL0, and then calculate the flow rate of the gaseous ammonia X1 required to achieve the calculated difference in output.

The processor 90a calculates the temperature T2 of the mixed gas X4 at the outlet of the mixer 4 based on the target flow rate of the gaseous ammonia X1 calculated in step S200 and the flow rate FL0 of the liquid ammonia X2 (step S202). As described above, the processor 90a can calculate the temperature T2 with using the map or the formula stored in the memory 90b.

The processor 90a determines whether the temperature T2 of the mixed gas X4 calculated in step S202 falls within a predetermined tolerance range or not (step S204). For example, the controller 90 may store the tolerance range in advance in the memory 90b, and the processor 90a may determine whether or not the calculated temperature T2 falls within the tolerance range stored in the memory 90b. Specifically, the processor 90a may determine whether the temperature T2 does not exceed the upper limit.

In step S204, if the temperature T2 of the mixed gas X4 falls within the tolerance range (YES), the processor 90a controls the first adjuster A1 to increase the flow rate FG0 of the gaseous ammonia X1 to the target flow rate calculated in step S200 (step S206), and terminates the operation. Note that when increasing the flow rate FG0 of the gaseous ammonia X1, the apparent cracking rate R2 increases. Accordingly, the apparent cracking rate R2 does not fall below the lower limit.

In step S204, if the temperature T2 of the mixed gas X4 does not fall within the tolerance range (NO), the processor 90a terminates the operation. In this case, for example, the controller 90 may notify the operator via the display or sound that the output of the combustor 5 cannot be increased to the target output.

The system 400 as described above has similar effects to those of the system 100.

In particular, the system 400 includes the first adjuster A1 that is provided upstream of the cracker 3 in the first line L1 and that adjusts the flow rate FG0 of the gaseous ammonia X1 flowing through the first line L1, the second adjuster A2 that is provided in the second line L2 and that adjusts the flow rate FL0 of the liquid ammonia X2 flowing through the second line L2, and the controller 90 that is communicatively connected to the first adjuster A1 and the second adjuster A2. The controller 90 is configured to execute obtaining the apparent cracking rate R2 of the gaseous ammonia X1 cracked in the cracker 3 in the mixed gas X4, obtaining the temperature T2 of the mixed gas X4, and controlling the first adjuster A1 and the second adjuster A2 such that the apparent cracking rate R2 does not fall below the predetermined lower limit and the temperature T2 of the mixed gas X4 does not exceed the predetermined upper limit. According to such a configuration, the combustibility of the mixed gas X4 can be maintained while cooling the cracked gas X3.

Although the embodiments of the present disclosure have been described above with reference to the accompanying drawings, the present disclosure is not limited thereto. It is obvious that a person skilled in the art can conceive of various examples of variations or modifications within the scope of the claims, which are also understood to belong to the technical scope of the present disclosure.

For example, in the above embodiments, the systems 100, 200, 300 and 400 include the mixer 4 on the first line L1. In other embodiments, the system may include an injector instead of the mixer 4. The injector is connected to the second line L2 and is provided in the first line L1 at a position downstream of the cracker 3. The injector injects the liquid ammonia into the cracked gas X3 flowing through the first line L1.

Furthermore, for example, in the system 400 according to the fourth embodiment, the first adjuster A1, the second adjuster A2, the temperature sensor S, and the controller 90 are added, with respect to the system 100 according to the first embodiment. In other embodiments, the first adjuster A1, the second adjuster A2, the temperature sensor S, and the controller 90 may be added to the system 200 according to the second embodiment or the system 300 according to the third embodiment.

The present disclosure can promote the use of ammonia to reduce CO₂ emissions, thus contributing to Sustainable Development Goals (SDGs), Goal 7 "Ensure access to affordable, reliable, sustainable and modern energy," for example.

What is claimed is:

1. An ammonia cracking system comprising:
a first line that is provided with ammonia;
a cracker that is provided in the first line and that generates cracked gas containing hydrogen from the ammonia; and
a second line that is fluidically connected to the first line at a position downstream of the cracker, the second line supplying liquid ammonia to the cracked gas flowing through the first line to generate mixed gas.

2. The ammonia cracking system according to claim 1, comprising a mixer that is provided in the first line at a position downstream of the cracker and that mixes the cracked gas from the cracker with the liquid ammonia from the second line.

3. The ammonia cracking system according to claim 1, comprising a tank that is fluidly connected to the first line and the second line, the tank including a chamber for storing ammonia in two phases including gaseous ammonia and liquid ammonia, the first line being connected to an upper part of the chamber, the second line being connected to a lower part of the chamber.

4. The ammonia cracking system according to claim 1, comprising:
a tank that is fluidically connected to the first line and the second line, the tank supplying liquid ammonia to each of the first line and the second line; and
a vaporizer that is provided in the first line between the tank and the cracker and that heats the liquid ammonia flowing through the first line to generate gaseous ammonia.

5. The ammonia cracking system according to claim 1, comprising:
a first adjuster that is provided in the first line at a position upstream of the cracker and that adjusts a flow rate of the ammonia flowing through the first line;
a second adjuster that is provided in the second line and that adjusts a flow rate of the liquid ammonia flowing through the second line; and
a controller that is communicatively connected to the first adjuster and the second adjuster, the controller being configured to execute:
obtaining an apparent cracking rate of gaseous ammonia cracked in the cracker in the mixed gas;
obtaining temperature of the mixed gas; and
controlling the first adjuster and the second adjuster such that the apparent cracking rate does not fall below a predetermined lower limit and the temperature of the mixed gas does not exceed a predetermined upper limit.

6. A method for cracking ammonia, including:
supplying ammonia to a first line;
generating cracked gas containing hydrogen from the ammonia by a cracker provided in the first line; and
supplying liquid ammonia from a second line that is fluidically connected to the first line at a position downstream of the cracker to the cracked gas flowing through the first line to generate a mixed gas.
